(19) United States
(12) Patent Application Publication
(10) Pub. No.: US 2023/0204016 A1
(43) Pub. Date: Jun. 29, 2023

(54) CAPILLARY ACTION PROPULSION SYSTEM AND METHOD

(71) Applicant: Scott M. Lanphier, Livermore, CA (US)

(72) Inventor: Scott M. Lanphier, Livermore, CA (US)

(21) Appl. No.: 17/646,211

(22) Filed: Dec. 28, 2021

(51) Int. Cl. F03G 7/06

(52) U.S. Cl. CPC F03G 7/0641; F03G 7/0633

(57) ABSTRACT

A capillary action propulsion system includes an absorbent material, at least one compression member, and a fluid. The absorbent material forms an endless path. At least one compression member compresses a portion of the absorbent material at a compression location. A fluid is disposed within the absorbent material in an unequal distribution with a first side of the absorbent material having more fluid than a second side. The absorbent material is configured to continuously rotate due to the at least one compression member compressing the portion of the absorbent material at the compression location causing the fluid to continuously remain unequally distributed within the absorbent material creating a weight imbalance in the absorbent material and a resulting moment. The fluid is configured to continuously rise, due to capillary action, within the absorbent material along the endless path from the compression location on the first side of the absorbent material.

### FIELD OF THE DISCLOSURE

The disclosure relates to capillary action propulsion systems and methods.

### BACKGROUND

The typical propulsion system requires a motor, a battery, or another power source. These propulsion systems require substantial power to be expended which can harm the environment and cost substantial money to operate. The capillary propulsion systems that exist are typically not very efficient and do not generate substantial mechanical energy.

A system and method is needed to overcome one or more issues of the existing propulsion systems and methods.

### SUMMARY

In one embodiment, a capillary action propulsion system is disclosed. The capillary action propulsion system includes an absorbent material, at least one compression member, and a fluid. The absorbent material forms an endless path. At least one compression member compresses a portion of the absorbent material at a compression location. A fluid is disposed within the absorbent material in an unequal distribution with a first side of the absorbent material having more fluid than a second side of the absorbent material. The absorbent material is configured to continuously rotate due to the at least one compression member compressing the portion of the absorbent material at the compression location causing the fluid to continuously remain unequally distributed within the absorbent material creating a weight imbalance in the absorbent material and a resulting moment. The fluid is configured to continuously rise, due to capillary action, within the absorbent material along the endless path from the compression location on the first side of the absorbent material.

In another embodiment, a method of capillary action propulsion is disclosed. In one step, absorbent material, forming an endless path, continuously rotates due to at least one compression member compressing a portion of the absorbent material at a compression location causing fluid to continuously remain unequally distributed within the absorbent material creating a weight imbalance in the absorbent material and a resulting moment with a first side of the absorbent material weighing more than a second side of the absorbent material. In another step, the fluid rises, due to capillary action, within the absorbent material along the endless path from the compression location on the first side of the absorbent material.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a side view of a portion of one embodiment of a capillary propulsion system with a side surface of a shell removed to show absorbent material which is empty of fluid;

FIG. 2 illustrates a cross-section view of FIG. 1 along line 2-2;

FIG. 3 illustrates the view of FIG. 1 with a side of the absorbent material partially filled with a fluid, and the shell disposed on a compression member;

FIG. 4 illustrates a top view of one embodiment of a capillary propulsion system which uses an assembly of arrays of the shell and absorbent material disclosed in FIGS. 1-3 to power an electrical generator;

FIG. 5 illustrates one embodiment of a partial segment of a material that may be used in the embodiment of FIGS. 1-4 for the absorbent material;

FIG. 6 illustrates one embodiment that can be used for longitudinally extending pores extending along the cross-section A-A through FIG. 5;

FIG. 7 illustrates another embodiment that can be used for the longitudinally extending pores extending along the cross-section A-A through FIG. 5;

FIG. 8 illustrates yet another embodiment that can be used for the longitudinally extending pores extending along the cross-section A-A through FIG. 5;

FIG. 9 illustrates a side view of a portion of one embodiment of a capillary propulsion system with a side surface of a shell removed to show absorbent material which is empty of fluid;

FIG. 10 illustrates a cross-section view of FIG. 9 along line 10-10;

FIG. 11 illustrates the view of FIG. 9 with a side of the absorbent material partially filled with a fluid;

FIG. 12 illustrates a side view of one embodiment of a capillary propulsion system which uses an array of the shell and absorbent material disclosed in FIGS. 9-11 to power an electrical generator;

FIG. 13 illustrates a side view of a portion of one embodiment of a capillary propulsion system with a side surface of a shell removed to show absorbent material which is empty of fluid;

FIG. 14 illustrates a cross-section view of FIG. 1 along line 14-14;

FIG. 15 illustrates the view of FIG. 13 with a side of the absorbent material partially filled with a fluid;

FIG. 16 illustrates a side view of one embodiment of a capillary propulsion system which uses an array of the shell and absorbent material disclosed in FIGS. 13-15 to power an electrical generator;

FIG. 17 illustrates a side view of a portion of one embodiment of a capillary propulsion system with a side surface of a shell removed to show absorbent material which is empty of fluid;

FIG. 18 illustrates a cross-section view of FIG. 17 along line 18-18;

FIG. 19 illustrates the view of FIG. 17 with a side of the absorbent material partially filled with a fluid;

FIG. 20 illustrates a side view of one embodiment of a capillary propulsion system which uses an array of the shell and absorbent material disclosed in FIGS. 17-19 to power an electrical generator;

FIG. 21 illustrates a side view of a portion of one embodiment of a capillary propulsion system with a side surface of a shell removed to show absorbent material which is empty of fluid;

FIG. 22 illustrates a cross-section view of FIG. 21 along line 22-22;

FIG. 23 illustrates the view of FIG. 21 with a side of the absorbent material partially filled with a fluid;

FIG. 24 illustrates a side, cross-sectional view of one embodiment of a capillary propulsion system which uses an array of the shell and absorbent material disclosed in FIGS. 21-23 to power an electrical generator; and

FIG. 25 illustrates one embodiment of a method of capillary action propulsion.

### DETAILED DESCRIPTION

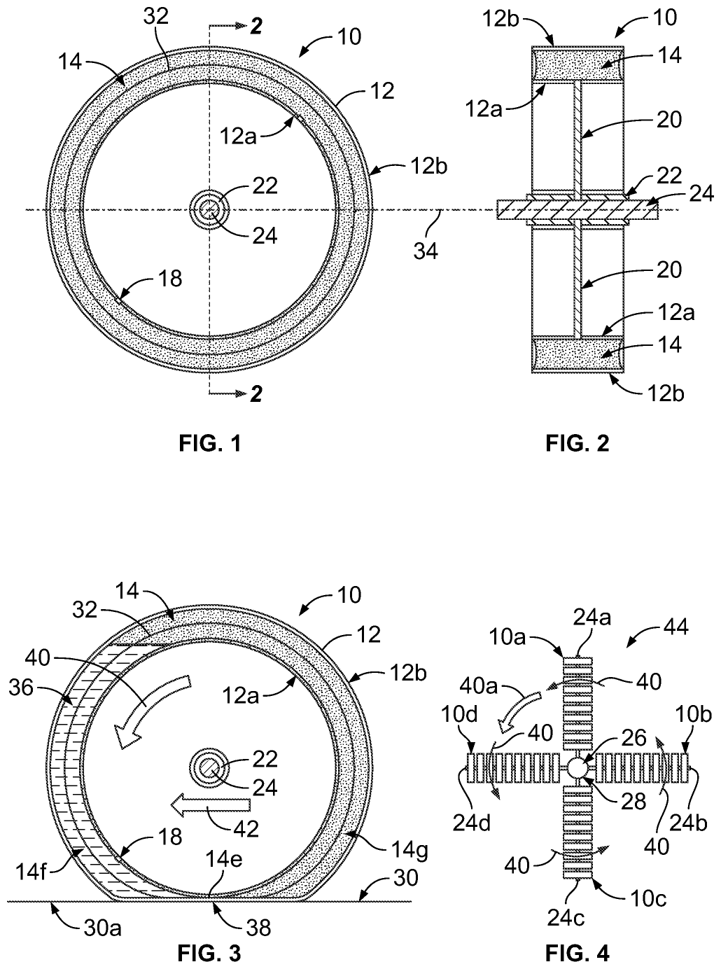

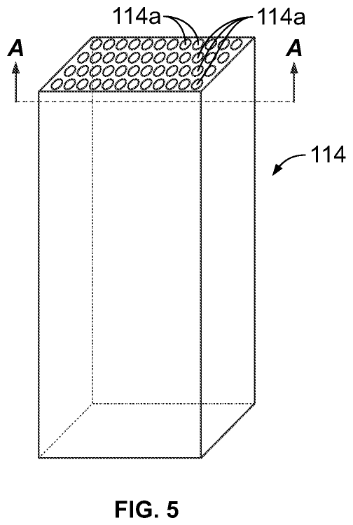

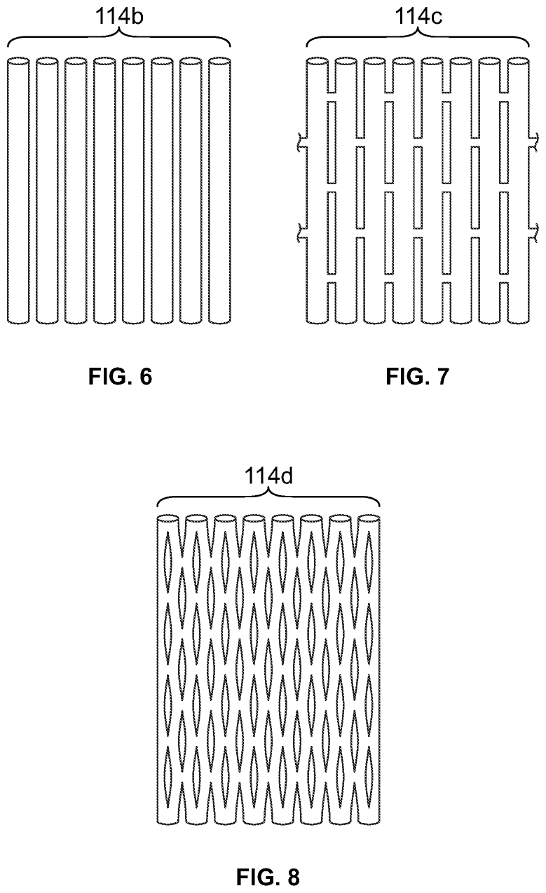

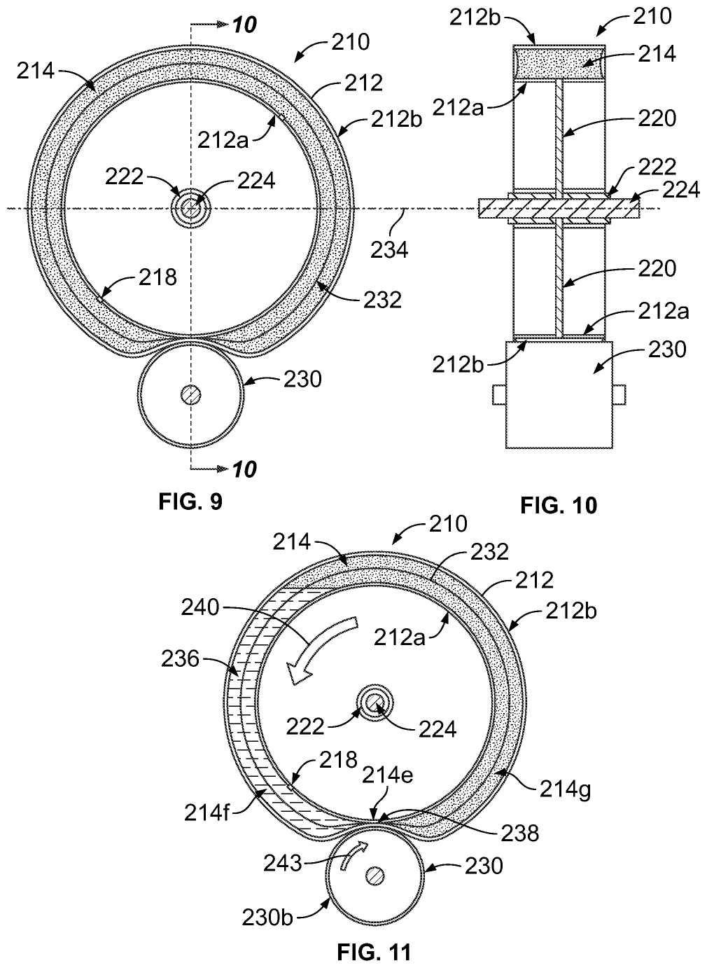

FIGS. 1-4 illustrate one embodiment of a capillary action propulsion system 10. As shown in FIGS. 1-4 collectively, the capillary action propulsion system 10 comprises a shell 12 having an inner surface 12a and an outer surface 12b, an absorbent material 14, a fill/drain hole 18, a plurality of spokes 20, a hub 22, an axle 24, an electric generator 26, a gear-box 28, and at least one compression member 30.

The axle 24 is fixedly attached to the hub 22. A plurality of spokes 20 fixedly extend from and between the hub 22 and the inner surface 12a. The shell 12, which is circular, is sealed. The outer surface 12b and the inner surface 12a can comprise two separate parts which are attached together to form the shell 12, or in another embodiment can comprise a single part forming the shell 12. The outer surface 12b is flexible, and the inner surface 12a is rigid. The absorbent material 14, which is circular, is disposed between the outer surface 12b and the inner surface 12a. The absorbent material 14 comprises a sponge. In other embodiments, the absorbent material 14 may comprise any type of absorbent material. The absorbent material 14 forms an endless path 32 which is circular. In other embodiments, the endless path 32 may comprise varying shapes which form an endless path. The axle 24, hub 22, plurality of spokes 20, inner surface 12a, absorbent material 14, and outer surface 12b are all fixedly attached and rotatably disposed together around an axis 34. A fluid 36 is disposed into the absorbent material 14 through the fill/drain hole 18 which is disposed in the inner surface 12a. The fill/drain hole 18 is sealed using a cap (not shown). In other embodiments, the fill/drain hole 18 may be disposed in the outer surface 12b. The shell 12 confines the fluid 36 within the absorbent material 14 so that it does not leak out of the shell 12.

FIG. 5 illustrates one embodiment of a partial segment of a material 114 that may be used in the embodiment of FIGS. 1-4 for the absorbent material 14. The material 114 comprises longitudinally extending pores 114a which may be extended along the endless path 32 of FIGS. 1-4 to efficiently flow the fluid 36 in one direction along the endless path 32. FIG. 6 illustrates one embodiment that can be used for the longitudinally extending pores 114a extending along the cross-section A-A through FIG. 5. As shown in FIG. 6, the longitudinally extending pores 114a extending along the cross-section A-A through FIG. 5 may comprise parallel, non-interconnected pores 114b. FIG. 7 illustrates another embodiment that can be used for the longitudinally extending pores 114a extending along the cross-section A-A through FIG. 5. As shown in FIG. 7, the longitudinally extending pores 114a extending along the cross-section A-A through FIG. 5 may comprise parallel, connected pores 114c. FIG. 8 illustrates yet another embodiment that can be used for the longitudinally extending pores 114a extending along the cross-section A-A through FIG. 5. As shown in FIG. 8, the longitudinally extending pores 114a extending along the cross-section A-A though FIG. 5 may comprise lattice-type, interconnected pores 114d. In other embodiments, the absorbent material 14 of FIGS. 1-4 may comprise pores in varying shapes, sizes, and configurations.

Referring back to FIGS. 1-4 collectively, the outer surface 12b of the shell 12 is disposed directly against the at least one compression member 30 which compresses a portion 14e of the absorbent material 14 at a compression location 38. The at least one compression member 30 comprises a rigid, fixed-in place surface 30a. In other embodiments, the at least one compression member 30 may vary. At the compression location 38, the rigid, fixed-in place surface 30a continuously compresses the flexible outer surface 12b towards the rigid inner surface 12a to continuously compress the portion 14e of the absorbent material 14 preventing fluid from traveling between sides 14f and 14g of the absorbent material 14 at the compression location 38. When the fluid 36 is disposed through the fill/drain hole 18 into the absorbent material 14, side 14f of the absorbent material 14 is partially or fully filled with the fluid 36 without side 14g filling due to the fill/drain hole 18 being disposed on side 14f of the absorbent material 14. The fluid 36 fill is stopped once side 14f of the absorbent material 14 is to the desired level and/or full of the fluid 36 which largely prevents the fluid 36 from traveling from side 14f to side 14g of the absorbent material 14.

The fixedly attached axle 24, hub 22, plurality of spokes 20, inner surface 12a, absorbent material 14, and outer surface 12b then begin to continuously rotate around the axis 34 in counter-clockwise direction 40 due to the fluid 36 being continually unequally distributed within the absorbent material 14 at side 14f of the absorbent material 14 as a result of the continuous compression at the compression location 38 of the portion 14e of the absorbent material 14 preventing the fluid 36 from transferring from side 14f to side 14g of the absorbent material 14. This unequal distribution creates a weight imbalance in the absorbent material 14, with side 14f of the absorbent material 14 weighing more than side 14g of the absorbent material, and a moment around axis 34 causing the continuous rotation of the axle 24 around the axis 34 in counter-clockwise direction 40. During this continuous rotation, the fluid 36 continuously rises, due to capillary action, within the absorbent material 14 along the endless path 32 from the compression location 38 on the side 14f of the absorbent material 14. Simultaneously, the capillary action propulsion system 10 continuously translates in direction 42 parallel to the rigid, fixed-in place surface 30a as a result of the continuous rotation of the axle 24 of the capillary action propulsion system 10 around the axis 34 in counter-clockwise direction 40.

As shown in FIG. 4, an assembly 44 of four separate, spaced-apart arrays 10a, 10b, 10c, and 10d of the capillary action propulsion system 10 of FIGS. 1-3 may be fixedly attached to common axles 24a, 24b, 24c, and 24d which are connected to or with the gear-box 28 and the electric generator 26, which are also connected. The four separate, spaced-apart arrays 10a, 10b, 10c, and 10d of the capillary action propulsion system 10 are each configured to continuously rotate in the counter-clockwise direction 40 with their respective common axles 24a, 24b, 24c, and 24d along a rigid, fixed-in place surface 30a, as a result of the above-described action, causing an overall counterclockwise rotation 40a of the assembly 44. The gear-box 28 is configured to adjust the revolutions-per-minute (RPM's) of the arrays 10a, 10b, 10c, and 10d. The electric generator 26 is configured to harness mechanical energy generated by the continuous rotation of the axles 24a, 24b, 24c, and 24d.

In other embodiments, the capillary action propulsion system 10 and assembly 44 of FIGS. 1-4 may be varied to utilize one or more differing components, to eliminate one or more of the components, and/or to make other modifications. Moreover, the directions of movement of the components of the capillary action propulsion system 10 and assembly 44 may be changed in other embodiments.

FIGS. 9-12 illustrate another embodiment of a capillary action propulsion system 210. As shown in FIGS. 9-12 collectively, the capillary action propulsion system 210 comprises a shell 212 having an inner surface 212a and an outer surface 212b, an absorbent material 214, a fill/drain hole 218, a plurality of spokes 220, a hub 222, an axle 224, an electric generator 226, a gear-box 228, and at least one compression member 230.

The axle 224 is fixedly attached to the hub 222. A plurality of spokes 220 fixedly extend from and between the hub 222 and the inner surface 212a. The shell 212, which is circular, is sealed. The outer surface 212b and the inner surface 212a can comprise two separate parts which are attached together to form the shell 212, or in another embodiment can comprise a single part forming the shell 212. The outer surface 212b is flexible, and the inner surface 212a is rigid. The absorbent material 214, which is circular, is disposed between the outer surface 212b and the inner surface 212a. The absorbent material 214 comprises a sponge. In other embodiments, the absorbent material 214 may comprise any type of absorbent material. The absorbent material 214 when uncompressed forms an endless path 232 which is circular. In other embodiments, the endless path 232 may comprise varying shapes which form an endless path. The axle 224, hub 222, plurality of spokes 220, inner surface 212a, absorbent material 214, and outer surface 212b are all fixedly attached and rotatably disposed together around an axis 234. A fluid 236 is disposed into the absorbent material 214 through the fill/drain hole 218 which is disposed in the inner surface 212a. The fill/drain hole 218 is sealed using a cap (not shown). In other embodiments, the fill/drain hole 218 may be disposed in the outer surface 212b. The shell 212 confines the fluid 236 within the absorbent material 214 so that it does not leak out of the shell 212.

FIG. 5 illustrates one embodiment of a partial segment of a material 114 that may be used in the embodiment of FIGS. 9-12 for the absorbent material 214. The material 114 comprises longitudinally extending pores 114a which may be extended along the endless path 232 of FIGS. 9-12 to efficiently flow the fluid 236 in one direction along the endless path 232. FIG. 6 illustrates one embodiment that can be used for the longitudinally extending pores 114a extending along the cross-section A-A through FIG. 5. As shown in FIG. 6, the longitudinally extending pores 114a extending along the cross-section A-A through FIG. 5 may comprise parallel, non-interconnected pores 114b. FIG. 7 illustrates another embodiment that can be used for the longitudinally extending pores 114a extending along the cross-section A-A through FIG. 5. As shown in FIG. 7, the longitudinally extending pores 114a extending along the cross-section A-A through FIG. 5 may comprise parallel, connected pores 114c. FIG. 8 illustrates yet another embodiment that can be used for the longitudinally extending pores 114a extending along the cross-section A-A through FIG. 5. As shown in FIG. 8, the longitudinally extending pores 114a extending along the cross-section A-A though FIG. 5 may comprise lattice-type, interconnected pores 114d. In other embodiments, the absorbent material 214 of FIGS. 9-12 may comprise pores in varying shapes, sizes, and configurations.

Referring back to FIGS. 9-12 collectively, the outer surface 212b of the shell 212 is disposed directly against the at least one compression member 230 which compresses a portion 214e of the absorbent material 214 at a compression location 238. The at least one compression member 230 comprises a rotatable compression wheel 230b. In other embodiments, the at least one compression member 230 may vary. At the compression location 238, the rotatable compression wheel 230b continuously compresses the flexible outer surface 212b towards the rigid inner surface 212a to continuously compress the portion 214e of the absorbent material 214 preventing fluid from traveling between sides 214f and 214g of the absorbent material 214 at the compression location 238. When the fluid 236 is disposed through the fill/drain hole 218 into the absorbent material 214, side 214f of the absorbent material 214 is partially or fully filled with the fluid 236 without side 214g filling due to the fill/drain hole 218 being disposed on side 214f of the absorbent material 214. The fluid 236 fill is stopped once side 214f of the absorbent material 214 is to the desired level and/or full of the fluid 236 which largely prevents the fluid 236 from traveling from side 214f to side 214g of the absorbent material 214.

The fixedly attached axle 224, hub 222, plurality of spokes 220, inner surface 212a, absorbent material 214, and outer surface 212b then begin to continuously rotate around the axis 234 in counter-clockwise direction 240 due to the fluid 236 being continually unequally distributed within the absorbent material 214 at side 214f of the absorbent material 214 as a result of the continuous compression at the compression location 238 of the portion 214e of the absorbent material 214 preventing the fluid 236 from transferring from side 214f to side 214g of the absorbent material 214. This unequal distribution creates a weight imbalance in the absorbent material 214, with side 214f of the absorbent material 214 weighing more than side 214g of the absorbent material, and a moment around the axis 234 causing the continuous rotation of the axle 224 around the axis 234 in counter-clockwise direction 240. At the same time, the rotatable compression wheel 230b rotates in clockwise direction 243 as a result of the force applied against it by the outer surface 212b rotating in counter-clockwise direction 240. During this continuous rotation, the fluid 236 continuously rises, due to capillary action, within the absorbent material 214 along the endless path 232 from the compression location 238 on the side 214f of the absorbent material 214.

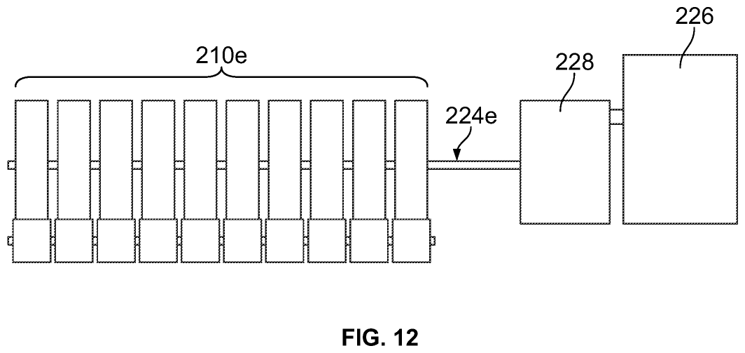

As shown in FIG. 12, an array 210e of the capillary action propulsion system 210 of FIGS. 9-11 may be fixedly attached to common axle 224e which is connected to or with the gear-box 228 and the electric generator 226, which are also connected. The array 210e of the capillary action propulsion system 210 is configured to continuously rotate the common axle 224e. The gear-box 228 is configured to adjust the revolutions-per-minute (RPM's) of the array 210e. The electric generator 226 is configured to harness mechanical energy generated by the continuous rotation of the axle 224e.

In other embodiments, the capillary action propulsion system 210 and array 210e of FIGS. 9-12 may be varied to utilize one or more differing components, to eliminate one or more of the components, and/or to make other modifications. Moreover, the directions of movement of the components of the capillary action propulsion system 210 and assembly 210e may be changed in other embodiments.

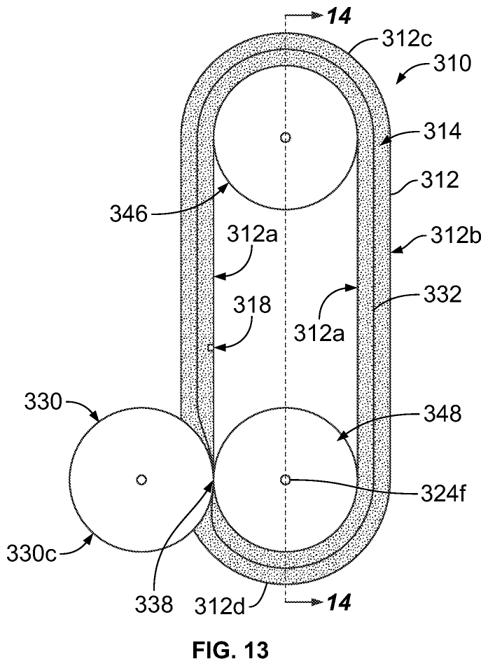

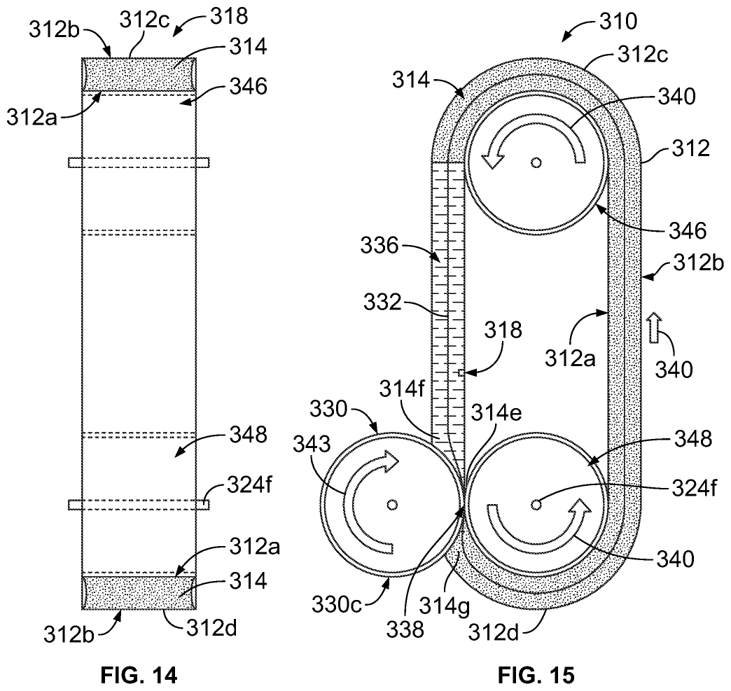

FIGS. 13-16 illustrate another embodiment of a capillary action propulsion system 310. As shown in FIGS. 13-16 collectively, the capillary action propulsion system 310 comprises a shell 312 having an inner surface 312a and an outer surface 312b, an absorbent material 314, a fill/drain hole 318, an electric generator 326, a gear-box 328, at least one compression member 330, a first rotatable tension wheel 346, and a second rotatable tension wheel 348.

The shell 312 is sealed. The outer surface 312b and the inner surface 312a can comprise two separate parts which are attached together to form the shell 312, or in another embodiment can comprise a single part forming the shell 312. The absorbent material 314 is disposed between the outer surface 312b and the inner surface 312a. The absorbent material 314 comprises a sponge. In other embodiments, the absorbent material 314 may comprise any type of absorbent material. Opposite ends 312c and 312d of the shell 312 are rotatably disposed around the respective first and second rotatable tension wheels 346 and 348. When uncompressed, the absorbent material 314 forms an endless path 332 (i.e. loop) within the shell 312. The endless path 332 is non-circular. A fluid 336 is disposed into the absorbent material 314 through the fill/drain hole 318 which is disposed in the inner surface 312a. The fill/drain hole 318 is sealed using a cap (not shown). In other embodiments, the fill/drain hole 318 may be disposed in the outer surface 312b. The shell 312 confines the fluid 336 within the absorbent material 314 so that it does not leak out of the shell 312. The inner surface 312a is rotatably disposed around the first and second rotatable tension wheels 346 and 348.

FIG. 5 illustrates one embodiment of a partial segment of a material 114 that may be used in the embodiment of FIGS. 13-16 for the absorbent material 314. The material 114 comprises longitudinally extending pores 114a which may be extended along the endless path 332 of FIGS. 13-16 to efficiently flow the fluid 336 in one direction along the endless path 332. FIG. 6 illustrates one embodiment that can be used for the longitudinally extending pores 114a extending along the cross-section A-A through FIG. 5. As shown in FIG. 6, the longitudinally extending pores 114a extending along the cross-section A-A through FIG. 5 may comprise parallel, non-interconnected pores 114b. FIG. 7 illustrates another embodiment that can be used for the longitudinally extending pores 114a extending along the cross-section A-A through FIG. 5. As shown in FIG. 7, the longitudinally extending pores 114a extending along the cross-section A-A through FIG. 5 may comprise parallel, connected pores 114c. FIG. 8 illustrates yet another embodiment that can be used for the longitudinally extending pores 114a extending along the cross-section A-A through FIG. 5. As shown in FIG. 8, the longitudinally extending pores 114a extending along the cross-section A-A though FIG. 5 may comprise lattice-type, interconnected pores 114d. In other embodiments, the absorbent material 314 of FIGS. 13-16 may comprise pores in varying shapes, sizes, and configurations.

Referring back to FIGS. 13-16 collectively, the outer surface 312b of the shell 312 is disposed directly against the at least one compression member 330 which compresses the outer portion of the shell 312b and a portion 314e of the absorbent material 314 at a compression location 338. The at least one compression member 330 comprises a rotatable compression wheel 330c. In other embodiments, the at least one compression member 330 may vary. At the compression location 338, the rotatable compression wheel 330c continuously compresses the outer surface 312b, which is flexible, towards the inner surface 312a which is disposed against the second rotatable tension wheel 348 causing continuous compression of the portion 314e of the absorbent material 314 preventing fluid from traveling between sides 314f and 314g of the absorbent material 314 at the compression location 338. When the fluid 336 is disposed through the fill/drain hole 318 into the absorbent material 314, side 314f of the absorbent material 314 is partially or fully filled with the fluid 336 without side 314g filling due to the fill/drain hole 318 being disposed on side 314f of the absorbent material 314. The fluid 336 fill is stopped once side 314f of the absorbent material 314 is to the desired level and/or full of the fluid 336 which largely prevents the fluid 336 from traveling from side 314f to side 314g of the absorbent material 314.

The shell 312 and the absorbent material 314 then begin to continuously rotate in counter-clockwise direction 340, around the first and second rotatable tension wheels 346 and 348, due to the fluid 336 being continually unequally distributed within the absorbent material 314 at side 314f of the absorbent material 314 as a result of the continuous compression at the compression location 338 of the portion 314e of the absorbent material 314 preventing the fluid 336 from transferring from side 314f to side 314g of the absorbent material 314. This unequal distribution creates a weight imbalance in the absorbent material 314, with side 314f of the absorbent material 314 weighing more than side 314g of the absorbent material, and a moment causing the continuous rotation in counter-clockwise direction 340. At the same time, the first and second rotatable tension wheels 346 and 348 rotate in counter-clockwise direction 340 due to the force applied against them by the inner surface 312a rotating in counter-clockwise direction 340. Simultaneously, the rotatable compression wheel 330c rotates in clockwise direction 343 as a result of the force applied against it by the outer surface 312b of the shell and by the second rotatable tension wheel 348 which both are rotating in counter-clockwise direction 340. During this continuous rotation, the fluid 336 continuously rises, due to capillary action, within the absorbent material 314 along the endless path 332 from the compression location 338 on the side 314f of the absorbent material 314.

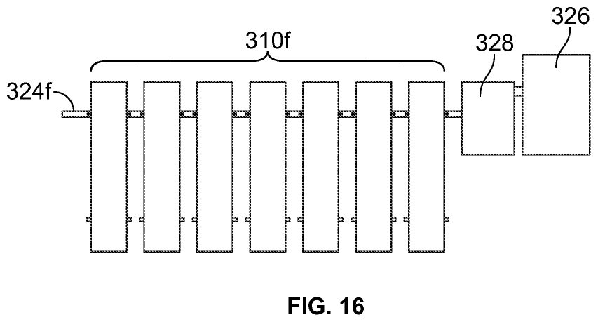

As shown in FIG. 16, an array 310f of the capillary action propulsion system 310 of FIGS. 13-15 may be fixedly attached to a common axle 324f which is connected to or with the gear-box 328 and the electric generator 326, which are also connected. As shown in FIGS. 13-15, the common axle 324f is connected to the second rotatable tension wheel 348. In other embodiments, the common axle 324f may be connected to the first rotatable tension wheel 346 or to the rotatable compression wheel 330c. In still other embodiments, a plurality of common axles 324f connected to the array 310f of the capillary action propulsion system 310 may be used. The array 310f of the capillary action propulsion system 310 is configured to continuously rotate the common axles 324f The gear-box 328 is configured to adjust the revolutions-per-minute (RPM's) of the array 310f. The electric generator 326 is configured to harness mechanical energy generated by the continuous rotation of the common axles 324f.

In other embodiments, the capillary action propulsion system 310 and array 310f of FIGS. 13-16 may be varied to utilize one or more differing components, to eliminate one or more of the components, and/or to make other modifications. Moreover, the directions of movement of the components of the capillary action propulsion system 310 and array 310f may be changed in other embodiments.

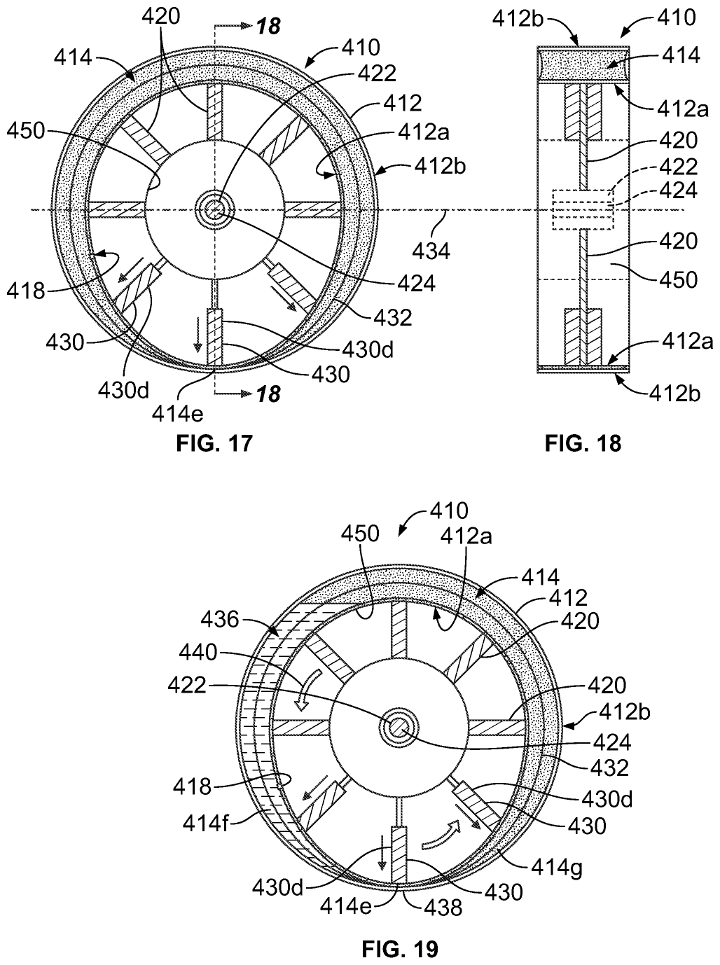

FIGS. 17-20 illustrate one embodiment of a capillary action propulsion system 410. As shown in FIGS. 17-20 collectively, the capillary action propulsion system 410 comprises a shell 412 having an inner surface 412a and an outer surface 412b, an absorbent material 414, a fill/drain hole 418, a plurality of spokes 420, a hub 422, an axle 424, an electric generator 426, a gear-box 428, at least one compression member 430, and a rigid member 450.

The axle 424 is fixedly attached with the hub 422 and the rigid member 450. The rigid member 450 is disposed concentrically within the inner surface 412a. A plurality of spokes 420 fixedly extend from and between the rigid member 450 and the inner surface 412a. The shell 412, which is circular, is sealed. The outer surface 412b and the inner surface 412a can comprise two separate parts which are attached together to form the shell 412, or in another embodiment can comprise a single part forming the shell 412. The outer surface 412b is rigid, and the inner surface 412a is semi-rigid remaining flexible enough to contort. The absorbent material 414, which is circular, is disposed between the outer surface 412b and the inner surface 412a. The absorbent material 414 comprises a sponge. In other embodiments, the absorbent material 414 may comprise any type of absorbent material. The absorbent material 414, when in an uncompressed state, forms an endless path 432 which is circular. In other embodiments, the endless path 432 may comprise varying shapes which form an endless path. The axle 424, hub 422, rigid member 450, plurality of spokes 420, inner surface 412a, absorbent material 414, and outer surface 412b are all fixedly attached and rotatably disposed together around an axis 434. A fluid 436 is disposed into the absorbent material 414 through the fill/drain hole 418 which is disposed in the inner surface 412a. The fill/drain hole 418 is sealed using a cap (not shown). In other embodiments, the fill/drain hole 418 may be disposed in the outer surface 412b. The shell 412 confines the fluid 436 within the absorbent material 414 so that it does not leak out of the shell 412.

FIG. 5 illustrates one embodiment of a partial segment of a material 114 that may be used in the embodiment of FIGS. 17-20 for the absorbent material 414. The material 114 comprises longitudinally extending pores 114a which may be extended along the endless path 432 of FIGS. 17-20 to efficiently flow the fluid 436 in one direction along the endless path 432. FIG. 6 illustrates one embodiment that can be used for the longitudinally extending pores 114a extending along the cross-section A-A through FIG. 5. As shown in FIG. 6, the longitudinally extending pores 114a extending along the cross-section A-A through FIG. 5 may comprise parallel, non-interconnected pores 114b. FIG. 7 illustrates another embodiment that can be used for the longitudinally extending pores 114a extending along the cross-section A-A through FIG. 5. As shown in FIG. 7, the longitudinally extending pores 114a extending along the cross-section A-A through FIG. 5 may comprise parallel, connected pores 114c. FIG. 8 illustrates yet another embodiment that can be used for the longitudinally extending pores 114a extending along the cross-section A-A through FIG. 5. As shown in FIG. 8, the longitudinally extending pores 114a extending along the cross-section A-A though FIG. 5 may comprise lattice-type, interconnected pores 114d. In other embodiments, the absorbent material 414 of FIGS. 17-20 may comprise pores in varying shapes, sizes, and configurations.

Referring back to FIGS. 17-20 collectively, the inner surface 412a of the shell 412 is disposed directly against the at least one compression member 430 which compresses a portion 414e of the absorbent material 414 at a compression location 438. The at least one compression member 430 comprises a plurality of weights 430d which are each moveably disposed on a separate respective spoke 420 between the inner surface 412a and the rigid member 450. The spokes 420 are dispersed in a circumferential, spaced-apart configuration around the rigid member 450 and within the inner surface 412. In such manner, the plurality of weights 430d are also dispersed in a circumferential, spaced-apart configuration around the rigid member 450 and within the inner surface 412. In other embodiments, the at least one compression member 430 may comprise any number of weights. In still other embodiments, the compression member 430 may vary in type. Each of the plurality of weights 430d, when its respective spoke 420 is disposed at the compression location 430 aligning the respective weight 430d at the compression location 430, asserts a force on the inner surface 412a compressing the inner surface 412a towards the outer surface 412b and contorting the inner surface 412a away from the rigid member 450 and towards the outer surface 412b. This causes the portion 414e of the absorbent material 414 to compress thereby preventing fluid from traveling between sides 414f and 414g of the absorbent material 414 at the compression location 438. When the fluid 436 is disposed through the fill/drain hole 418 into the absorbent material 414, side 414f of the absorbent material 414 is partially or fully filled with the fluid 436 without side 414g filling due to the fill/drain hole 418 being disposed on side 414f of the absorbent material 414. The fluid 436 fill is stopped once side 414f of the absorbent material 414 is to the desired level and/or full of the fluid 436 which largely prevents the fluid 436 from traveling from side 414f to side 414g of the absorbent material 414.

The fixedly attached axle 424, hub 422, rigid member 450, plurality of spokes 420, inner surface 412a, absorbent material 414, and outer surface 412b then begin to continuously rotate around the axis 434 in counter-clockwise direction 440 due to the fluid 436 being continually unequally distributed within the absorbent material 414 at side 414f of the absorbent material 414 as a result of the continuous compression at the compression location 438 of the portion 414e of the absorbent material 414 preventing the fluid 436 from transferring from side 414f to side 414g of the absorbent material 414. As the plurality of spokes 420 and their respective weight 430d continuously rotate in counter-clockwise direction 440 the portion 414e of the absorbent material 414 that was compressed also rotates in counter-clockwise direction 440 away from the compression location 438 causing the weight 430d on each respective spoke 420 to move/slide along their respective spoke 420 towards the rigid member 450. This gradually decreases the force on the inner surface 412a causing the inner surface 412a to de-contort towards the rigid member 450 and away from the outer surface 412b causing the portion 414e of the absorbent material 414 to decompress. During this continuous rotation, the absorbent material 414 is continuously compressed at compression location 438 as a result of the circumferential spacing of the spokes 420 and weights 430d which causes one weight 430d to always be moving/rotating to the compression location 438 as another weight 430d moves/rotates away from the compression location 438. The unequal distribution of the fluid 436 in the absorbent material 414 creates a weight imbalance in the absorbent material 414, with side 414f of the absorbent material 414 weighing more than side 414g of the absorbent material, and a moment around the axis 434 causing the continuous rotation of the axle 424 around the axis 434 in counter-clockwise direction 440. During this continuous rotation, the fluid 436 continuously rises, due to capillary action, within the absorbent material 414 along the endless path 432 from the compression location 438 on the side 414f of the absorbent material 414.

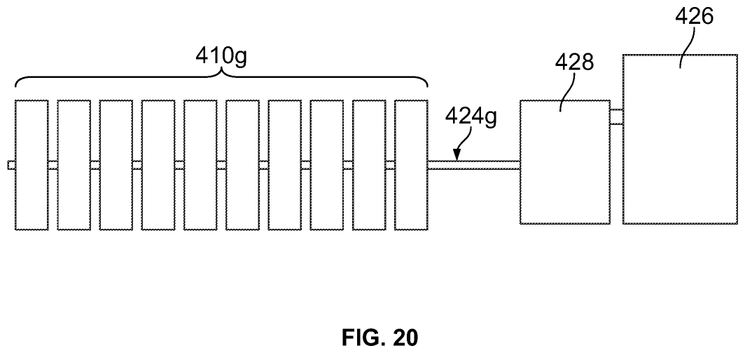

As shown in FIG. 20, an array 410g of the capillary action propulsion system 410 of FIGS. 17-19 may be fixedly attached to common axle 424g which is connected to or with the gear-box 428 and the electric generator 426, which are also connected. The array 410g of the capillary action propulsion system 410 is configured to continuously rotate counter-clockwise, as a result of the above-described action, causing the same continuous rotation of the fixedly attached common axle 424g. The gear-box 428 is configured to adjust the revolutions-per-minute (RPM's) of the array 410g. The electric generator 426 is configured to harness mechanical energy generated by the continuous rotation of the common axle 424g.

In other embodiments, the capillary action propulsion system 410 and array 410g of FIGS. 17-20 may be varied to utilize one or more differing components, to eliminate one or more of the components, and/or to make other modifications. Moreover, the directions of movement of the components of the capillary action propulsion system 410 and array 410g may be changed in other embodiments.

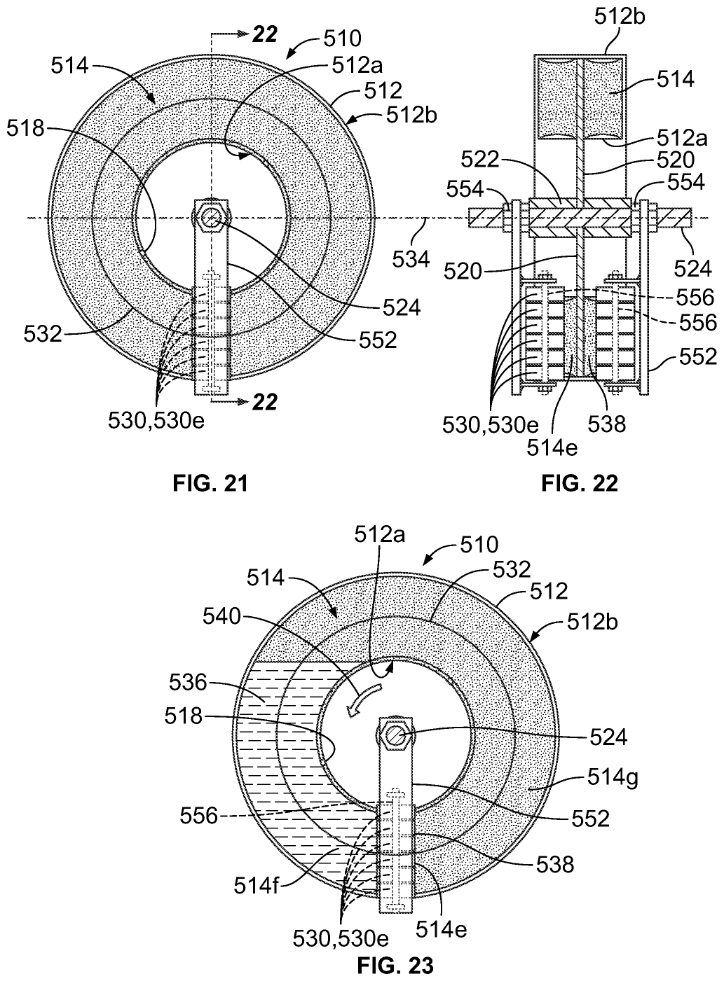

FIGS. 21-24 illustrate one embodiment of a capillary action propulsion system 510. As shown in FIGS. 21-24 collectively, the capillary action propulsion system 510 comprises a shell 512 having an inner surface 512a, an outer surface 512b, and opposed side surfaces (removed to show the absorbent material 514) extending between the inner surface 512a and the outer surface 512b, an absorbent material 514, a fill/drain hole 518, a plurality of spokes 520, a hub 522, an axle 524, an electric generator 526, a gear-box 528, at least one compression member 530, and a bracket 552.

The axle 524 is fixedly attached to the hub 522. A plurality of spokes 520 fixedly extend from and between the hub 522 and the inner surface 512a. The shell 512, which is circular, is sealed. The outer surface 512b and the inner surface 512a can comprise two separate parts which are attached together to form the shell 512, or in another embodiment can comprise a single part forming the shell 512. The opposed side surfaces (not shown) of the shell 512 extending between the inner surface 512a and the outer surface 512b are flexible. The absorbent material 514, which is circular, is disposed within the shell 512 between the opposed side surfaces (not shown) extending between the inner surface 512a and the outer surface 512b. The absorbent material 514 comprises a sponge. In other embodiments, the absorbent material 514 may comprise any type of absorbent material. The absorbent material 514, when uncompressed, forms an endless path 532 which is circular. In other embodiments, the endless path 532 may comprise varying shapes which form an endless path. The axle 524, hub 522, plurality of spokes 520, inner surface 512a, outer surface 512b, opposed side surfaces (not shown) of the shell 512 extending between the inner surface 512a and the outer surface 512b, and absorbent material 514 are all fixedly attached and rotatably disposed together around an axis 534. The bracket 552 is attached with bearings 554 to the axle 524. The bracket stays stationary while the axle 524 rotates within the bracket 552. The bracket 552 is attached to the at least one compression member 530.

A fluid 536 is disposed into the absorbent material 514 through the fill/drain hole 518 which is disposed in the inner surface 512a. The fill/drain hole 518 is sealed using a cap (not shown). In other embodiments, the fill/drain hole 518 may be disposed in the outer surface 512b. The shell 512 confines the fluid 536 within the absorbent material 514 so that it does not leak out of the shell 512.

FIG. 5 illustrates one embodiment of a partial segment of a material 114 that may be used in the embodiment of FIGS. 21-24 for the absorbent material 514. The material 114 comprises longitudinally extending pores 114a which may be extended along the endless path 532 of FIGS. 21-24 to efficiently flow the fluid 536 in one direction along the endless path 532. FIG. 6 illustrates one embodiment that can be used for the longitudinally extending pores 114a extending along the cross-section A-A through FIG. 5. As shown in FIG. 6, the longitudinally extending pores 114a extending along the cross-section A-A through FIG. 5 may comprise parallel, non-interconnected pores 114b. FIG. 7 illustrates another embodiment that can be used for the longitudinally extending pores 114a extending along the cross-section A-A through FIG. 5. As shown in FIG. 7, the longitudinally extending pores 114a extending along the cross-section A-A through FIG. 5 may comprise parallel, connected pores 114c. FIG. 8 illustrates yet another embodiment that can be used for the longitudinally extending pores 114a extending along the cross-section A-A through FIG. 5. As shown in FIG. 8, the longitudinally extending pores 114a extending along the cross-section A-A though FIG. 5 may comprise lattice-type, interconnected pores 114d. In other embodiments, the absorbent material 514 of FIGS. 21-24 may comprise pores in varying shapes, sizes, and configurations.

Referring back to FIGS. 21-24 collectively, the opposed side surfaces (not shown) of the shell 512 extending between the inner surface 512a and the outer surface 512b are disposed directly against the at least one compression member 530 which compresses a portion 514e of the absorbent material 514 at a compression location 538. The at least one compression member 530 comprises a plurality of compression wheels 530e attached to the bracket 552. In other embodiments, the at least one compression member 530 may vary. At the compression location 538, the plurality of compression wheels 530e are disposed against the opposed side surfaces (not shown) of the shell 512 extending between the inner surface 512a and outer surface 512b to continuously compresses the opposed side surfaces towards one another thereby continuously compressing the portion 514e of the absorbent material 514 preventing fluid from traveling between sides 514f and 514g of the absorbent material 514 at the compression location 538. When the fluid 536 is disposed through the fill/drain hole 518 into the absorbent material 514, side 514f of the absorbent material 514 is partially or fully filled with the fluid 536 without side 514g filling due to the fill/drain hole 518 being disposed on side 514f of the absorbent material 514. The fluid 536 fill is stopped once side 514f of the absorbent material 514 is to the desired level and/or full of the fluid 536 which largely prevents the fluid 536 from traveling from side 514f to side 514g of the absorbent material 514.

The fixedly attached axle 524, hub 522, plurality of spokes 520, inner surface 512a, outer surface 512b, opposed side surfaces (not shown) of the shell 512 extending between the inner surface 512a and outer surface 512b, and absorbent material 514 then begin to continuously rotate around the axis 534 in counter-clockwise direction 540 due to the fluid 536 being continually unequally distributed within the absorbent material 514 at side 514f of the absorbent material 514 as a result of the continuous compression at the compression location 538 of the portion 514e of the absorbent material 514 preventing the fluid 536 from transferring from side 514f to side 514g of the absorbent material 514. During this rotation, the plurality of compression wheels 530 on the opposed side surfaces (not shown) of the shell 512 also continuously rotate in a counter-clockwise direction 540 around axis/axle 556, which is perpendicular to axis 534, as a result of the force placed on them by the continuously rotating opposed side surfaces (not shown) of the shell 512. The unequal distribution of the fluid 536 in the absorbent material 514 creates a weight imbalance in the absorbent material 514, with side 514f of the absorbent material 514 weighing more than side 514g of the absorbent material, and a moment around the axis 534 causing the continuous rotation of the axle 524 around the axis 534 in counter-clockwise direction 540. During this continuous rotation, the fluid 536 continuously rises, due to capillary action, within the absorbent material 514 along the endless path 532 from the compression location 538 on the side 514f of the absorbent material 514.

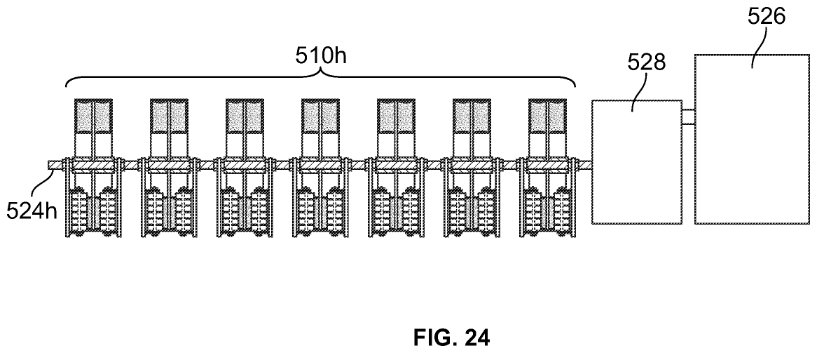

As shown in FIG. 24, an array 510h of the capillary action propulsion system 510 of FIGS. 21-23 may be fixedly attached to common axle 524h which is connected to or with the gear-box 528 and the electric generator 526, which are also connected. The array 510h of the capillary action propulsion system 510 is configured to continuously rotate counter-clockwise, as a result of the above-described action, causing the same continuous rotation of the fixedly attached common axle 524h. The gear-box 528 is configured to adjust the revolutions-per-minute (RPM's) of the array 510h. The electric generator 526 is configured to harness mechanical energy generated by the continuous rotation of the common axle 524h.

In other embodiments, the capillary action propulsion system 510 and array 510h of FIGS. 21-24 may be varied to utilize one or more differing components, to eliminate one or more of the components, and/or to make other modifications. Moreover, the directions of movement of the components of the capillary action propulsion system 510 and array 510h may be changed in other embodiments.

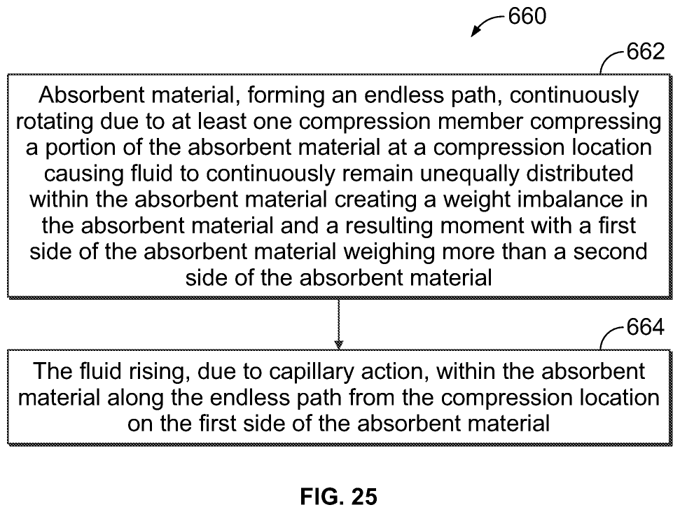

FIG. 25 illustrates one embodiment of a method 660 of capillary action propulsion. The method 660 may utilize any of the capillary action propulsion systems disclosed herein. In other embodiments, the method 660 may utilize varying capillary action propulsion systems. In step 662, absorbent material, forming an endless path, continuously rotates due to at least one compression member compressing a portion of the absorbent material at a compression location causing fluid to continuously remain unequally distributed within the absorbent material creating a weight imbalance in the absorbent material and a resulting moment with a first side of the absorbent material weighing more than a second side of the absorbent material. In step 664, the fluid rises, due to capillary action, within the absorbent material along the endless path from the compression location on the first side of the absorbent material.

In another embodiment, an optional method step comprises continuously rotating a shell, which is sealed, within which the absorbent material is disposed confining the fluid within the absorbent material.

In another embodiment, an optional method step comprises disposing the fluid into the first side but not the second side of the absorbent material using a fill/drain hole disposed in the shell on the first side of the absorbent material.

In another embodiment, optional method steps comprise: continuously rotating an axle due to the continuation rotation of the absorbent material; and harnessing mechanical energy generated by the continuous rotation of the axle with an electric generator.

In another embodiment, optional method steps comprise: continuously rotating the axle with an array of the absorbent material; and adjusting RPM's (revolutions per minute) of the array with a gear-box connected to the electric generator.

In another embodiment, an optional method step comprises compressing, at the compression location, a flexible outer surface of the shell towards a rigid inner surface of the shell by disposing the at least one compression member, comprising a rigid, fixed-in-place surface, directly against the flexible outer surface at the compression location to compress the portion of the absorbent material at the compression location.

In another embodiment, optional method steps comprise: the at least one compression member, comprising a rotatable compression wheel disposed at the compression location directly against a flexible outer surface of the shell, compressing the flexible outer surface at the compression location towards a rigid inner surface of the shell to compress the portion of the absorbent material at the compression location; and the rotatable compression wheel rotating in an opposite direction as the absorbent material.

In another embodiment, option method steps comprise: the shell continuously rotating around rotating first and second tension wheels; and at the compression location the at least one compression member, comprising a rotating compression wheel, compressing an outer surface of the shell towards an inner surface of the shell which is disposed against the rotating second tension wheel causing the portion of the absorbent material to compress.

In another embodiment, optional method steps comprise: the at least one compression member, comprising at least one of a plurality of weights, asserting a force on an inner surface of the shell at the compression location causing the inner surface to contort towards an outer surface of the shell causing the portion of the absorbent material to compress at the compression location; and as the portion of the absorbent material rotates away from the compression location, at least one of the plurality of weights moving to assert less force on the inner surface adjacent the portion of the absorbent material resulting in the inner surface de-contorting away from the outer surface and the portion of the absorbent material decompressing.

In another embodiment, an optional method step comprises the at least one compression member comprising a plurality of compression wheels, disposed against opposed side surfaces of the shell, compressing the shell and the portion of the absorbent material at the compression location.

In other embodiments, one or more steps of the method may be not followed, may be modified, or may be changed in order, or one or more additional steps may be added.

One or more embodiments of the disclosure may reduce one or more issues experienced by one or more of the prior art. The capillary propulsion systems and methods of the disclosure are configured to provide substantial mechanical energy without any power source using the molecular attractiveness of a fluid within an absorbing material. This is accomplished by using a high absorbency absorbent material which encourages the movement of the fluid within the absorbent material such that the absorption of the fluid in the absorbent material is accelerated by continuous compression of a portion of the absorbent material.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A capillary action propulsion system comprising:
an absorbent material forming an endless path;
at least one compression member compressing a portion of the absorbent material at a compression location; and
a fluid disposed within the absorbent material in an unequal distribution with a first side of the absorbent material having more fluid than a second side of the absorbent material;
wherein the absorbent material is configured to continuously rotate due to the at least one compression member compressing the portion of the absorbent material at the compression location causing the fluid to continuously remain unequally distributed within the absorbent material creating a weight imbalance in the absorbent material and a resulting moment, the fluid configured to continuously rise, due to capillary action, within the absorbent material along the endless path from the compression location on the first side of the absorbent material.

2. The capillary action propulsion system of claim 1 further comprising a shell which is sealed, the absorbent material disposed within the shell causing the fluid to be confined within the absorbent material, the shell configured to continuously rotate with the absorbent material.

3. The capillary action propulsion system of claim 2 further comprising a fill/drain hole disposed in the shell on the first side of the absorbent material.

4. The capillary action propulsion system of claim 1 further comprising an axle configured to continuously rotate with the absorbent material, the axle connected to or with an electric generator configured to harness mechanical energy generated by the continuous rotation of the axle.

5. The capillary action propulsion system of claim 4 further comprising a gear-box connected to the electric generator, and an array of the continuously rotating absorbent material, the axle configured to continuously rotate with the array, the gear-box configured to adjust RPM's of the array.

6. The capillary action propulsion system of claim 1 wherein the absorbent material comprises a sponge.

7. The capillary action propulsion system of claim 1 wherein the absorbent material comprises parallel, non-interconnected pores running along the endless path.

8. The capillary action propulsion system of claim 1 wherein the absorbent material comprises parallel, connected pores running along the endless path.

9. The capillary action propulsion system of claim 1 wherein the absorbent material comprises lattice-type, interconnected pores running along the endless path.

10. The capillary action propulsion system of claim 1 wherein the at least one compression member comprises a rigid, fixed-in place surface.

11. The capillary action propulsion system of claim 2 wherein an inner surface of the shell is rigid, an outer surface of the shell is flexible, and the at least one compression member comprises a rigid, fixed-in-place surface disposed, at the compression location, directly against the outer surface, the rigid, fixed-in-place surface compressing the outer surface at the compression location towards the inner surface to compress the portion of the absorbent material at the compression location.

12. The capillary action propulsion system of claim 1 wherein the at least one compression member comprises a rotatable compression wheel.

13. The capillary action propulsion system of claim 2 wherein an inner surface of the shell is rigid, an outer surface of the shell is flexible, and the at least one compression member comprises a rotatable compression wheel disposed, at the compression location, directly against the outer surface, the rotatable compression wheel compressing the outer surface at the compression location towards the inner surface to compress the portion of the absorbent material at the compression location, the rotatable compression wheel configured to rotate in an opposite direction as the absorbent material.

14. The capillary action propulsion system of claim 1 wherein the at least one compression member comprises a rotatable compression wheel.

15. The capillary action propulsion system of claim 2 further comprising first and second rotatable tension wheels, wherein the at least one compression member comprises a rotatable compression wheel, an inner surface of the shell is rotatably disposed against and around the first and second rotatable tension wheels, and at the compression location the rotatable compression wheel is disposed against an outer surface of the shell compressing the outer surface towards the inner surface of the shell which is disposed against the second rotatable tension wheel causing the portion of the absorbent material to compress.

16. The capillary action propulsion system of claim 1 wherein the at least one compression member comprises at least one weight.

17. The capillary action propulsion system of claim 1 wherein the at least one compression member comprises a plurality of spaced-apart weights which are configured to continuously rotate with the absorbent material and alternately compress the absorbent material at the compression location and decompress the absorbent material away from the compression location.

18. The capillary action propulsion system of claim 2 further comprising a rigid member disposed within an inner surface of the shell, the at least one compression member comprising a plurality of weights moveably disposed between the inner surface and the rigid member, the inner surface being semi-rigid yet flexible enough to contort, and an outer surface of the shell being rigid, wherein at the compression location at least one of the plurality of weights adjacent the portion of the absorbent material is configured to assert a force on the inner surface causing the inner surface to contort away from the rigid member towards the outer surface to compress the portion of the absorbent material at the compression location, and as the portion of the absorbent material rotates away from the compression location the at least one of the plurality of weights is configured to likewise rotate away from the compression location and move towards the rigid member decreasing the force on the inner surface causing the inner surface to de-contort towards the rigid member and away from the outer surface causing the portion of the absorbent material to decompress.

19. The capillary action propulsion system of claim 17 further comprising a plurality of spaced-apart spokes fixedly connected between the rigid member and the inner surface, each the plurality of weights slideably disposed on one of the plurality of spaced-apart spokes, wherein when each spoke is located at the compression location its respective weight compresses the portion of the absorbent material adjacent the spoke at the compression location, and when each spoke and the portion of the absorbent material adjacent the spoke is rotated away from the compression location its respective weight decompresses the portion of the absorbent material adjacent the spoke.

20. The capillary action propulsion system of claim 1 wherein the at least one compression member comprises a plurality of compression wheels.

21. The capillary action propulsion system of claim 2 wherein the at least one compression member comprises a plurality of compression wheels disposed against opposed side surfaces of the shell.

22. A method of capillary action propulsion comprising:
absorbent material, forming an endless path, continuously rotating due to at least one compression member compressing a portion of the absorbent material at a compression location causing fluid to continuously remain unequally distributed within the absorbent material creating a weight imbalance in the absorbent material and a resulting moment with a first side of the absorbent material weighing more than a second side of the absorbent material; and
the fluid rising, due to capillary action, within the absorbent material along the endless path from the compression location on the first side of the absorbent material.

23. The method of claim 22 further comprising:
continuously rotating a shell, which is sealed, within which the absorbent material is disposed confining the fluid within the absorbent material.

24. The method of claim 23 further comprising:
disposing the fluid into the first side but not the second side of the absorbent material using a fill/drain hole disposed in the shell on the first side of the absorbent material.

25. The method of claim 22 further comprising:
continuously rotating an axle due to the continuation rotation of the absorbent material; and
harnessing mechanical energy generated by the continuous rotation of the axle with an electric generator.

26. The method of claim 25 further comprising:
continuously rotating the axle with an array of the absorbent material; and
adjusting RPM's of the array with a gear-box connected to the electric generator.

27. The method of claim 23 further comprising:
compressing, at the compression location, a flexible outer surface of the shell towards a rigid inner surface of the shell by disposing the at least one compression member, comprising a rigid, fixed-in-place surface, directly against the flexible outer surface at the compression location to compress the portion of the absorbent material at the compression location.

28. The method of claim 23 further comprising:
the at least one compression member, comprising a rotatable compression wheel disposed at the compression location directly against a flexible outer surface of the shell, compressing the flexible outer surface at the compression location towards a rigid inner surface of the shell to compress the portion of the absorbent material at the compression location; and
the rotatable compression wheel rotating in an opposite direction as the absorbent material.

29. The method of claim 23 further comprising:
the shell continuously rotating around rotating first and second tension wheels; and
at the compression location the at least one compression member, comprising a rotating compression wheel, compressing an outer surface of the shell towards an inner surface of the shell which is disposed against the rotating second tension wheel causing the portion of the absorbent material to compress.

30. The method of claim 23 further comprising:
the at least one compression member, comprising at least one of a plurality of weights, asserting a force on an inner surface of the shell at the compression location causing the inner surface to contort towards an outer surface of the shell causing the portion of the absorbent material to compress at the compression location; and
as the portion of the absorbent material rotates away from the compression location, the at least one of the plurality of weights moving to assert less force on the inner surface adjacent the portion of the absorbent material resulting in the inner surface de-contorting away from the outer surface and the portion of the absorbent material decompressing.

31. The method of claim 23 further comprising:
the at least one compression member comprising a plurality of compression wheels, disposed against opposed side surfaces of the shell, compressing the shell and the portion of the absorbent material at the compression location.
